(19) United States
(12) Patent Application Publication
(10) Pub. No.: US 2012/0283956 A1
(43) Pub. Date: Nov. 8, 2012

(54) METHOD AND SYSTEM FOR PREDICTING SELECTIVE CANCER DRUG TARGETS

(75) Inventors: Eytan RUPPIN, Reut (IL); Tomer Shlomi, Tel Aviv (IL); Ori Folger, Tel Aviv (IL); Eyal Gottlieb, Glasgow (GB); Christian Frezza, Glasgow (GB)

(73) Assignees: RAMOT AT TEL-AVIV UNIVERSITY LTD., Tel-Aviv (IL); Cancer Research Technology Limited, Glasgow (GB); Technion Research and Development Foundation Ltd., Haifa (IL)

(21) Appl. No.: 13/410,950

(22) Filed: Mar. 2, 2012

Related U.S. Application Data
(60) Provisional application No. 61/448,418, filed on Mar. 2, 2011.

(51) Int. Cl. G06F 19/26

(52) U.S. Cl. 702/19

(57) ABSTRACT

A method for creating a metabolic map of metabolic reactions by selecting metabolic reactions active in cancer cells. A core set of metabolic reactions occurring in the cancer cells is designated. For each permutation, whether inhibition of the k-th non-core reaction together with inhibition of all previously deleted non-core reactions results in inhibition of any of the core reactions or results in inhibition of the flux of biomass metabolites to biomass is determined. If inhibition of the k-th non-core reaction and inhibition of all previously deleted non-core reactions does not result in inhibition of any core reactions and does not result in inhibition of the flux of biomass metabolites to biomass, then the k-th non-core reaction is deleted from the set of non-core reactions. The number of permutations for which the k-th non-core reaction is not deleted is determined and a metabolic map is then created based on that number.

### FIELD OF THE INVENTION

This invention relates to computational methods in bioinformatics.

### LIST OF REFERENCES

The following documents are considered to be relevant for an understanding of the background of the invention.
1. Vander Heiden, M. G., Cantley, L. C. & Thompson, C. B. Understanding the Warburg effect: the metabolic requirements of cell proliferation. Science 324, 1029-33 (2009).
2. Price, N. D., Reed, J. L. & Palsson, B. O. Genome-scale models of microbial cells: evaluating the consequences of constraints. Nat Rev Microbiol 2, 886-97 (2004).
3. Price, N. D., Papin, J. A., Schilling, C. H. & Palsson, B. O. Genome-scale microbial in silico models: the constraints-based approach. Trends Biotechnol 21, 162-9 (2003).
4. Duarte, N. C. et al. Global reconstruction of the human metabolic network based on genomic and bibliomic data. Proc Natl Acad Sci USA 104, 1777-82 (2007).
5. Ma, H. et al. The Edinburgh human metabolic network reconstruction and its functional analysis. Mol Syst Biol 3, 135 (2007).
6. Lee, D. S. et al. The implications of human metabolic network topology for disease comorbidity. Proc Natl Acad Sci USA 105, 9880-5 (2008).
7. Shlomi, T., Cabili, M. N., Herrgard, M. J., Palsson, B. O. & Ruppin, E. Network-based prediction of human tissue-specific metabolism. Nat Biotechnol 26, 1003-10 (2008).
8. Shlomi, T., Cabili, M. N. & Ruppin, E. Predicting metabolic biomarkers of human inborn errors of metabolism. Mol Syst Biol 5, 263 (2009).
9. Jerby, L., Shlomi, T. & Ruppin, E. Computational reconstruction of tissue-specific metabolic models: application to human liver metabolism. Molecular systems biology 6, 1 (2010).
10. Lee, J. K. et al. A strategy for predicting the chemosensitivity of human cancers and its application to drug discovery. Proc Natl Acad Sci USA 104, 13086-91 (2007).
11. Bamford, S. et al. The COSMIC (Catalogue of Somatic Mutations in Cancer) database and website. British Journal of Cancer 91, 355-358 (2004).
12. Partridge, A. H., Burstein, H. J. & Winer, E. P. Side effects of chemotherapy and combined chemohormonal therapy in women with early-stage breast cancer. J Natl Cancer Inst Monogr, 135-42 (2001).
13. Wishart, D. S. et al. The human cerebrospinal fluid metabolome. J Chromatogr B Analyt Technol Biomed Life Sci 871, 164-73 (2008).
14. Kaelin, W. G., Jr. The concept of synthetic lethality in the context of anticancer therapy. Nat Rev Cancer 5, 689-98 (2005).
15. Stelling, J., Klamt, S., Bettenbrock, K., Schuster, S. & Gilles, E. D. Metabolic network structure determines key aspects of functionality and regulation. Nature 420, 190-3 (2002).
16. Harrison, R., Papp, B., Pal, C., Oliver, S. G. & Delneri, D. Plasticity of genetic interactions in metabolic networks of yeast. Proc Natl Acad Sci USA 104, 2307-12 (2007).
17. Deutscher, D., Meilijson, I., Kupiec, M. & Ruppin, E. Multiple knockouts analysis of genetic robustness in the yeast metabolic metwork. Nature Genetics 38, 993-998 (2006).
18. Berenbaum, M. C. What is synergy? Pharmacol Rev 41, 93-141 (1989).
19. Segre, D., Deluna, A., Church, G. M. & Kishony, R. Modular epistasis in yeast metabolism. Nat Genet. 37, 77-83 (2005).
20. Greyer, M. R., Schepartz, S. A. & Chabner, B. A. The National Cancer Institute: cancer drug discovery and development program. Semin Oncol 19, 622-38 (1992).
21. Forbes, S. A. et al. The Catalogue of Somatic Mutations in Cancer (COSMIC). Curr Protoc Hum Genet Chapter 10, Unit 10 11 (2008).
22. Huret, J. L., Senon, S., Bernheim, A. & Dessen, P. An Atlas on genes and chromosomes in oncology and haematology. Cell Mol Biol (Noisy-le-grand) 50, 805-7 (2004).
23. Cohen, Y., Chemit, A., Sirota, P. & Modan, B. Cancer morbidity in psychiatric patients: influence of lithium carbonate treatment. Med Oncol 15, 32-6 (1998).
24. Chang, H. C., Lee, T. H., Chuang, L. Y., Yen, M. H. & Hung, W. C. Inhibitory effect of mimosine on proliferation of human lung cancer cells is mediated by multiple mechanisms. Cancer Lett 145, 1-8 (1999).
25. Else, M. et al. Long-term follow-up of 233 patients with hairy cell leukaemia, treated initially with pentostatin or cladribine, at a median of 16 years from diagnosis. Br J Haematol 145, 733-40 (2009).
26. Luo, B. et al. Highly parallel identification of essential genes in cancer cells. Proceedings of the National Academy of Sciences of the United States of America, 20380-20385 (2008).
27. Forster, J., Famili, I., Palsson, B. O. & Nielsen, J. Large-scale evaluation of in silico gene deletions in Saccharomyces cerevisiae. Omics 7, 193-202 (2003).
28. Varma, A., Boesch, B. W. & Palsson, B. O. Biochemical production capabilities of escherichia coli. Biotechnol Bioeng 42, 59-73 (1993).

The interest in studying cancer metabolism has recently grown in light of the decreasing number of newly released anticancer drugs, the development of metabolite profiling technologies and metabolic network databases, and due to increased efforts to target metabolic diseases in the pharmaceutical industry. During the development of cancer, malignant cells modify their metabolism to meet the requirements of cellular proliferation, thus facilitating the uptake and incorporation of nutrients into biomass'.

Genome-scale computational modeling approaches have been used to predict the metabolic state of fast-growing microorganisms². In particular, flux balance analysis (FBA) is a constraint-based modeling (CBM) approach that is suitable for modeling cancer metabolism as it assumes that a cell is under selective pressure to increase its growth rate, and hence searches for metabolic flux distributions that produce essential biomass precursors at high rates³. A fundamental step towards large-scale modeling of human metabolism has been taken in recent studies^{4,5}, which reconstructed a generic (non tissue-specific) human metabolic network based on an extensive evaluation of genomic and bibliomic data. The potential clinical utility of a generic human metabolic model has already been demonstrated, showing its ability to identify reactions causally related to hemolytic anemia⁴, to predict potential drug targets for treating hypercholesterolemia⁴, disease co-morbidity⁶ and tissue-specificity of disease genes⁷, and in identifying diagnostic biomarkers for Inborn Errors of Metabolism (IEMs)⁸.

U.S. Pat. No. 7,788,041 to Palsson et al. discloses a method for predicting physiological function in humans. The method utilizes a data structure relating a plurality of reactants to a plurality of reactions, where each of the reactions includes one or more reactants identified as a substrate of the reaction, one or more reactants identified as a product of the reaction and a stoichiometric coefficient relating the substrate and the product. The method also utilizes a constraint set for the plurality of reactions, and an objective function. At least one flux distribution is sought that minimizes or maximizes the objective function when the constraint set is applied to the data structure, thereby predicting a physiological function.

Jerby et al.⁹ discloses an algorithm for the reconstruction of tissue-specific genome-scale models of human metabolism. The algorithm generates a tissue-specific model from the generic human model by integrating a variety of tissue-specific molecular data sources, including literature-based knowledge, transcriptomic, proteomic, metabolomic and phenotypic data. Applying the algorithm, they constructed a genome-scale stoichiometric model of hepatic metabolism.

### SUMMARY OF THE INVENTION

In one aspect, the present invention provides a computer implemented method for generating a metabolic map of one or more cancer cells, comprising metabolic reactions that are active in the one or more cancer cells from among the metabolic reactions that occur in a predetermined organism from which the cells are derived. The cancer cells may be, for example, established cancer cell lines, or cells of one or more individuals subject to a specific cancer type.

The method utilizes a set of N metabolic reactions that can occur in the predetermined organism from which the one or more cells are derived. The method also utilizes a subset of the set of N predetermined reactions, referred to herein as the “core set” of reactions, having a level of activity in the one or more cells above a predetermined threshold as determined by one or more predetermined criteria, such as a high level of mRNA expression across the cells of a gene encoding the enzyme which catalyzes the reaction, or a non negligible concentration of metabolites produced uniquely by the reaction. Reactions in the predetermined set of metabolic reactions not included in the core set are referred to herein as “non-core reactions”. Non-core reactions are selected from the predetermined set of reactions and are added to the set of core reactions, as described in detail below, to produce the metabolic model of the one or more cancer cells.

In accordance with this aspect of the invention, the contribution of a non-core reaction to biomass production and to the core reactions in the one or more cells is determined in order to decide whether or not to include the non-core reaction in the metabolic model. This may be done, for example, by determining the effect of inhibiting the non-core reaction on the potential activity level of the core reactions and on the steady-state consumption of biomass precursors required for cellular proliferation.

In another of its aspects, the invention provides a method for determining the relative significance of a set of one or more target metabolic reactions to biomass production in cancer cells compared with normal cells. In accordance with this aspect of the invention, in the cancer cells, a first rate of biomass production x₁ is determined when none of the target metabolic reactions is inhibited and a second rate of biomass production x₂ is determined when all of the target metabolic reactions are inhibited. In the healthy cells, a first rate of activity of each of an integer n of predetermined test metabolic reactions, y₁, . . . yₙ is determined when each of the target metabolic reactions is not inhibited and a second rate of activity of the n test metabolic reactions z₁ . . . zₙ is determined when all of the target metabolic reaction are inhibited. A selectivity score S is then calculated for the set of target metabolic reactions using the algebraic expression S=(1−x2/x1)*min(zi/yi).

In still another of its aspects, the invention provides a method for determining a level of synergistic inhibition of biomass production of a set of K metabolic reactions R₁, R₂, . . . , R_{K}, in cancer cells. In accordance with this aspect of the invention, a rate of biomass production yⱼ in the cancer cells is determined when all of the reactions R₁ . . . Rⱼ₋₁, Rⱼ₊₁, . . . , R_{K} are inhibited and the reaction Rj is not inhibited. A rate of biomass production z is then determined in the cancer cells when all of the reactions R₁ . . . R_{K} are inhibited. A synergy score S′ of the K reactions R₁, . . . , R_{K} is then calculated using the algebraic expression S′=min(1−(z/yⱼ). The method may further comprise a step of identifying sets of synthetically lethal reactions which are sets of reactions having a score S′ above a predetermined threshold.

Thus, in one of its aspects, the present invention provides a computer implemented method for creating a metabolic map of metabolic reactions by selecting metabolic reactions that are active in one or more cancer cells from a predetermined set of an integer N of metabolic reactions that can occur in a predetermined organism from which the one or more cells are derived, the method embodied in a set of instructions stored on a computer readable medium, the instructions capable of being executed by a computer processor, the method, comprising:

designating a core set of an integer M of metabolic reactions from the predetermined set of N metabolic reactions, the M core reactions occurring in the predetermined cell types of the organism or occurring under the predetermined conditions of the organism;
(a) for j=1 to an integer n of predetermined permutations of the metabolic reactions not in the core set of metabolic reactions:
   (i) for k=1 to N-M, determining whether inhibition of the k-th non-core reaction together with inhibition of all previously deleted non-core reactions results in inhibition of any one or more of the core reactions or results in inhibition of the flux of biomass metabolites to biomass;
   (ii) if inhibition of the k-th non-core reaction together with inhibition of all previously deleted non-core reactions does not result in inhibition of any one or more of the core reactions and does not result in inhibition of the flux of biomass metabolites to biomass, deleting the k-th non-core reaction from the set of non-core reactions;
(b) calculating cₖ, cₖ being the number of permutations in the predetermined set of permutations for which the k-th non-core reaction is not deleted,
(c) determining a maximum value c of the cₖ for which inhibition of all non-core reactions having a cₖ less than or equal to c does not result in inhibition of any one or more of the core reactions or biomass production;
(d) determining a metabolic map to be the set of N metabolic reactions after deletion of the non-core reactions having a cₖ less than or equal to c.

The method may further comprise a step before step (c) of assigning a maximum flux to an uptake reaction of each of a plurality of metabolites, and a step (d) further comprising a condition that the flux of the uptake reaction of each of the plurality of metabolites is less than the maximum uptake flux of the metabolite.

The step of determining whether inhibition of the k-th non-core reaction together with inhibition of all previously deleted non-core reactions results in inhibition of any one or more of the core reactions or biomass production may comprise:
(i) for each core reaction,
   determining whether a flux assignment to each reaction in the predetermined set of N reactions exists satisfying a first set of conditions comprising:
      1. the flux of the k-th non-core reaction in the permutation is below a first predetermined threshold;
      2. the flux of any previously deleted non-core reactions is below a second predetermined threshold;
      3. the flux of the core reaction is above a predetermined third threshold;
      4. the net flux of all metabolites is below a fourth predetermined threshold;
(ii) determining whether a flux assignment to each reaction in the predetermined set of N reactions exists satisfying a second set of conditions comprising:
   1. the flux of the k-th non-core reaction in the permutation is below a first predetermined threshold;
   2. the flux of any previously deleted non-core reactions is below a second predetermined threshold;
   3. the flux of the biomass production reaction is above a third predetermined threshold;
   4. the net flux of all metabolites is below a fourth predetermined threshold; and
      if a flux assignment does not exist satisfying the first set of conditions for at least one core reaction or if a flux assignment does not exist satisfying the second set of conditions, determining that inhibition of the k-th non-core reaction together with inhibition of all previously deleted non-core reactions results in inhibition of any one or more of the core reactions or biomass production.

In the method of the invention, the calculation of the flux of biomass metabolites to biomass may comprises assigning a coefficient for each of a plurality of cellular metabolites, the coefficient being indicative of relative abundance of the cellular metabolite in a predetermined population of cells, and calculating the flux of biomass metabolites to biomass in a calculation involving the assigned coefficients.

The invention also provides a method for determining the relative significance of a set of one or more target metabolic reactions in cancer cells compared with normal, the method embodied in a set of instructions stored on a computer readable medium, the instructions capable of being executed by a computer processor, the method comprising:
(a) determining in the cancer cells a first rate of biomass production x₁ in the cancer cells when each of the one or more target metabolic reactions is not inhibited;
(b) determining in the cancer cells a second rate of biomass production x₂ in the cancer cells when all of the target metabolic reactions are inhibited;
(c) determining in the healthy cells a first rate of activity of an integer n of one or more predetermined test metabolic reactions y1 . . . yn in the healthy cells when each of the target metabolic reactions is not inhibited;
(d) determining in the cancer cells a second rate of activity of the n predetermined test metabolic reactions z₁ . . . zₙ in the healthy cells when all of the target metabolic reaction are inhibited; and
(e) calculating a selectivity score S of the set of target metabolic reactions using the algebraic expression S=(1−x2/x1)*min(zi/yi).

The step of determining a rate of biomass production in the cancer cells may comprise:

designating a core set of an integer M of metabolic reactions from the predetermined set of N metabolic reactions, the M core reactions occurring in the predetermined cell types of the organism or occurring under the predetermined conditions of the organism;
(a) for j=1 to an integer n of predetermined permutations of the metabolic reactions not in the core set of metabolic reactions:
   (i) for k=1 to N−M, determining whether inhibition of the k-th non-core reaction together with inhibition of all previously deleted non-core reactions results in inhibition of any one or more of the core reactions or results in inhibition of the flux of biomass metabolites to biomass;
   (ii) if inhibition of the k-th non-core reaction together with inhibition of all previously deleted non-core reactions does not result in inhibition of any one or more of the core reactions and does not result in inhibition of the flux of biomass metabolites to biomass, deleting the k-th non-core reaction from the set of non-core reactions;
(b) calculating cₖ, cₖ being the number of permutations in the predetermined set of permutations for which the k-th non-core reaction is not deleted,
(c) determining a maximum value c of the cₖ for which inhibition of all non-core reactions having a cₖ less than or equal to c does not result in inhibition of any one or more of the core reactions or biomass production;
(d) determining a metabolic map to be the set of N metabolic reactions after deletion of the non-core reactions having a cₖ less than or equal to c.

The method may further comprise a step of identifying sets of one or more metabolic reactions that are potential targets of anti-cancer drugs, wherein a set of metabolic reaction that is a potential target of an anti-cancer drug has a score S above a predetermined threshold.

The invention also provides a method for determining a level of synergistic inhibition of biomass production of a set of K metabolic reactions R₁, R₂, . . . R_{K}, in cancer cells, comprising:
(a) for j from 1 to K, determining in the cancer cells a rate of biomass production yj when all of the reactions R₁, . . . Rⱼ₋₁, Rⱼ₊₁, . . . R_{K} are inhibited and the reaction Rj is not inhibited;
(b) for j from 1 to K, determining in the cancer cells a rate of biomass production z when all of the reactions R₁, . . . R_{K} are inhibited;
(c) calculating a synergy score S′ of the K reactions R1, . . . RK using the algebraic expression S′=min(1−(z/yj)

The method may further comprise a step of identifying sets of synthetically lethal reactions, a synthetically lethal set of reactions having a score S′ above a predetermined threshold.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 shows the distribution of the sensitivity score of 204 genes that were predicted to be growth-inducing;

FIG. 2a shows the selectivity and synergy of predicted target gene pairs;

FIG. 2b shows a network of pathway associations of synergistic and highly selective drug target pairs;

FIG. 3a shows a schematic illustration of the expected relation between an efficacy of a drug and the expression of genes that have a synthetic lethal interaction with the drug's target;

FIG. 3b shows a distribution of efficacy-expression correlation values for the set of predicted synthetic lethal drug-gene pairs, and for a background distribution of random pairs;

FIG. 4 shows the drugs predicted to target specific cancer types based on chromosomal loss of synthetic lethal participant genes;

FIG. 5 shows the number of predicted synergistic and selective drug target pairs involving different genes with known somatic mutations in cancer;

FIG. 6 shows a flow chart for a method of generating a metabolic map of a cell; and

FIG. 7 depicts a block diagram of a host computer system suitable for implementing the present invention.

### DETAILED DESCRIPTION OF THE INVENTION

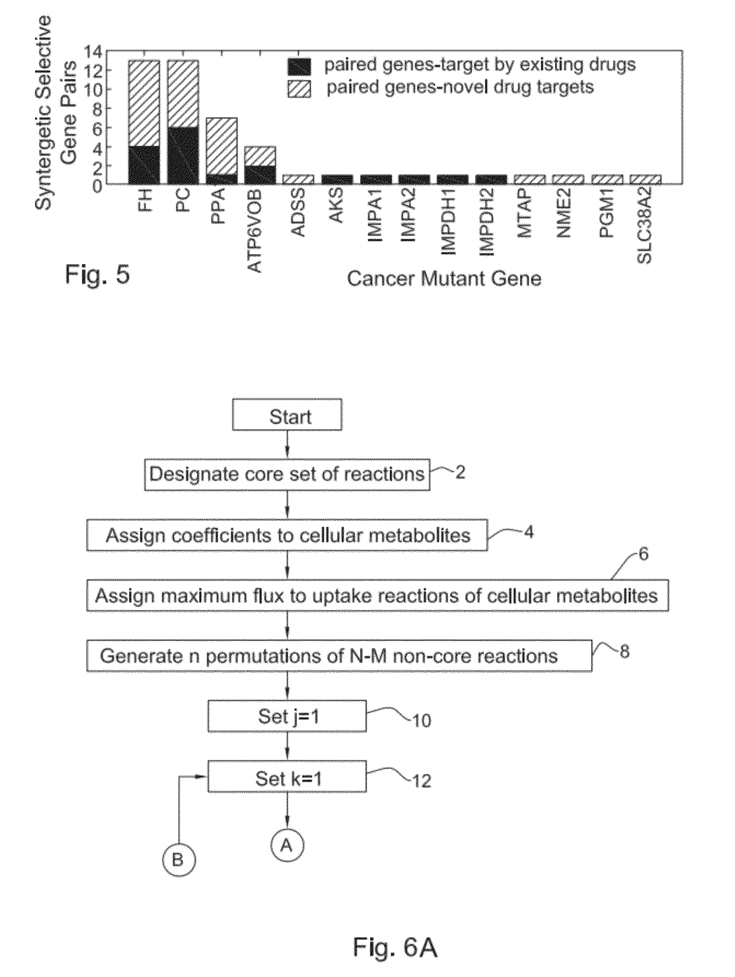

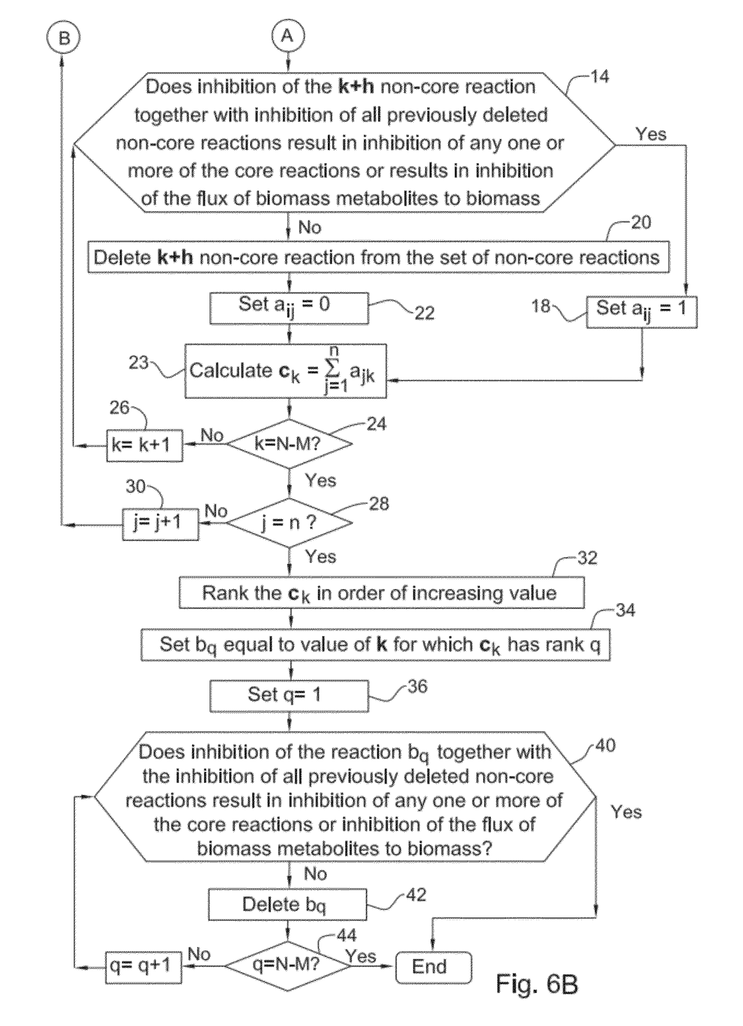

FIG. 6 shows a method for generating a metabolic map of a cell in accordance with one embodiment of the invention. The process begins with step 2 in which a core set of an integer M of metabolic reactions is designated from among the reactions in a predetermined set of N metabolic reactions. For each of a plurality of cellular metabolites, a coefficient is assigned indicative of relative abundance of the cellular metabolite in a predetermined population of cells (step 4). A maximum flux is then assigned to an uptake reaction of each of a plurality of metabolites (step 6).

Now, in step 8, a predetermined number n of permutations of the set of non-core reactions are generated. An index j of the permutations is set to 1 (step 10) and an index k is set to 1 (step 12). The process then continues with step 14 where it is determined whether inhibition of the k-th non-core reaction together with inhibition of all previously deleted non-core reactions results in inhibition of any one or more of the core reactions or results in inhibition of the flux of biomass metabolites to biomass. This may be done, for example, by determining whether a set of conditions, referred to herein as the “first set of flux conditions”, is satisfied for the current values of j and k.
(iii) for each core reaction,
   determining whether a flux assignment to each reaction in the predetermined set of N reactions exists satisfying a first set of conditions comprising:
      1. the flux of the k-th non-core reaction in the permutation is below a first predetermined threshold;
      2. the flux of any previously deleted non-core reactions is below a second predetermined threshold;
      3. the flux of the core reaction is above a predetermined third threshold;
      4. the net flux of all metabolites is below a fourth predetermined threshold;
(iv) determining whether a flux assignment to each reaction in the predetermined set of N reactions exists satisfying a second set of conditions comprising:
   1. the flux of the k-th non-core reaction in the permutation is below a first predetermined threshold;
   2. the flux of any previously deleted non-core reactions is below a second predetermined threshold;
   3. the flux of the biomass production reaction is above a predetermined third threshold;
   4. the net flux of all metabolites is below a fourth predetermined threshold;

If yes, aⱼₖ is set to 1 (step 18). Otherwise, the k-th non-core reaction is deleted from the set of non-core reactions (step 20) and aⱼₖ is set to 0 (step 22).

The process now continues with step 23 where a parameter cₖ is calculated using the algebraic expression

$${c}_{k} = {\sum }_{j = 1}^{n} {a}_{jk}$$

The process now continues with step 24 where it is determined whether k=N−M, where N−M is the number of non-core reactions. If no, then in step 26, k is increased by 1 and the process returns to step 14. If yes, then in step 28, it is determined whether j=n, where n is the number of predetermined permutations on the set of non-core reactions. If no, then j is increased by 1 in step 30, and the process returns to step 12 with k set to 1. If yes, then the cₖ are ranked in order of increasing value (step 32) and a parameter b_{q} is defined that is equal to the value of k for which cₖ has rank q.

Now, in step 36, q is set to 1, and in step 40 it is determined whether inhibition of the reaction bq together with the inhibition of all previously deleted non-core reactions results in inhibition of any one or more of the core reactions or inhibition of the flux of biomass metabolites to biomass. This may be done, for example, by determining whether for each of the core reactions and for the conversion of biomass metabolites to biomass, there exists a flux assignment to each reaction in the predetermined set of N reactions satisfying: the following set of conditions, referred to herein as “second set of flux conditions”:
1. The flux of the q-th non-core reaction in the permutation is below a sixth predetermined threshold.
   2. The flux of any previously deleted non-core reactions is below a seventh predetermined threshold.
   3. The flux of the core reaction is above a predetermined eighth threshold.
   4. The flux of the uptake reaction of each of the plurality of metabolites is less than the maximum uptake flux of the metabolite.
   5. The net flux of all metabolites is below a ninth predetermined threshold.

If inhibition of the reaction b_{q} together with the inhibition of all previously deleted non-core reactions does not result in inhibition of any one or more of the core reactions and does not result in inhibition of the flux of biomass metabolites to biomass, then the non-core reaction b_{q} is deleted from the set of non-core reactions (step 42). It is then determined whether q=N−M (step 44). If no, q is increased by 1 (step 46), and the process returns to step 38. If q=N−M, then the process terminates. If inhibition of the reaction b_{q} together with the inhibition of all previously deleted non-core reactions does results in inhibition of any one or more of the core reactions or results in inhibition of the flux of biomass metabolites to biomass, then the process terminates.

### Results

### Example 1

In this example, the invention was used to construct a generic cancer metabolic model in which major metabolic alterations are sought that are common across several cancer types. Genes were knocked-down one at a time, and the resulting simulated growth rate was recorded. A set of 204 growth-inducing genes, whose knockdown induced a reduction in growth rate of at least 1%, was obtained. The set of growth-inducing was found to be ranked as highly essential based on shRNA gene knockdown data³⁴ (Kolmogorov-Smirnov p-value=0.0045). The predicted set of growth inducing genes was compared with a set of genes in which cancer somatic mutations have been reported in the literature¹¹, finding a high level of enrichment (hypergeometric p-value of 0.002). For comparison, the predictive performance of the gene expression data and the generic human metabolic network were evaluated separately, and it was observed that that either source alone is a significantly worse predictor of both shRNA gene essentiality and cancer mutations.

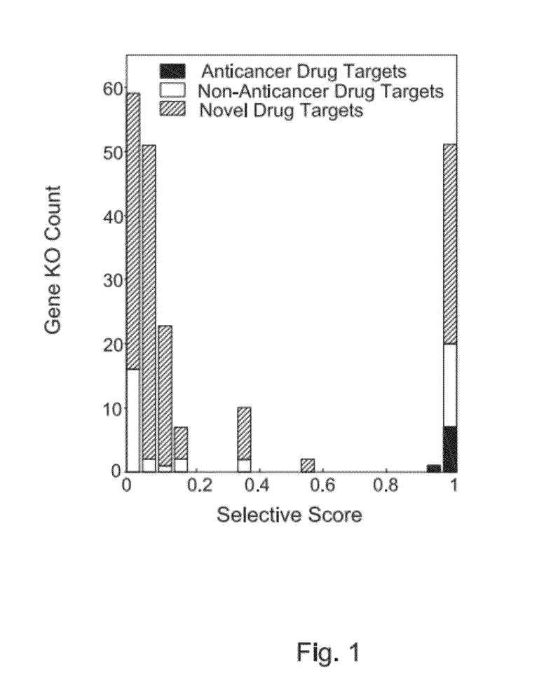

While reducing cancer proliferation rate, potential anticancer drugs should minimize the damage caused to healthy tissues. To predict the potential damage caused by such drugs, the generic human model may be used to simulate the effect of gene knockdowns on ATP production, a vital biochemical function of every cell. Based on these predictions, a selectivity score can be defined for each gene, representing the extent to which its knockdown reduces cancer growth compared to its effect on ATP production in healthy cells. A selectivity score of 1 denotes a highly selective knockdown that completely eliminates cancer growth without affecting ATP production of healthy cells, and a score of 0 denotes a highly nonselective knockdown. As shown in FIG. 1, the resulting distribution was bimodal. Out of the 204 genes that were predicted to be growth-inducing in the cancer model, 52 had a high selectivity score (above 0.9), and the remaining 152 genes had a low score (below 0.6). As a further measure of gene knockdown selectivity, the extent to which knockdowns selectively inhibit cancer growth versus inhibiting the proliferation of normal, rapidly dividing cells (utilizing the generic human metabolic model to represent the metabolism of normal cells). The knockdown of 49 out of the 52 genes identified above was found to similarly inhibit growth in the generic model, reflecting likely damage to proliferation of healthy cells, which is a very common side effect of chemotherapy treatments ¹².

The 52 predicted selective growth-inducing genes contain 8 out of 24 known targets of 14 FDA-approved metabolic anticancer drugs based on DrugBank¹³, representing a highly significant enrichment (hypergeometric p-value<6·10⁻⁷). Notably, the predicted nonselective growth-inducing genes are not associated with any cancer drugs. Moving from the gene to the drug level and simulating drug treatments by concurrently knocking down multiple genes targeted by the same drug, we successfully identified all three antimetabolites as highly selective, correctly predicting 11 (78%) out of all 14 FDA-approved metabolic anticancer drugs to be highly selective.

The set of 52 predicted selective genes contained 13 additional genes that are targeted by existing non-cancer drugs. However, quite remarkably, all of these predicted drugs except for one are currently under experimental testing for cancer therapy. Eight of these genes are targeted by drugs already approved by the FDA for the treatment of various non-cancer diseases (e.g. antimalarial treatment, hypercholesterolemia, obesity, etc), and five genes are targeted by experimental drugs. The remaining 31 (out of the original 52) highly selective genes are without any known drug that currently targets them, and form interesting candidates for potential drug targeting. Notably, these novel drug targets span a broad set of potential anticancer target pathways. Many of them participate in the same metabolic pathways as other anticancer drug targets.

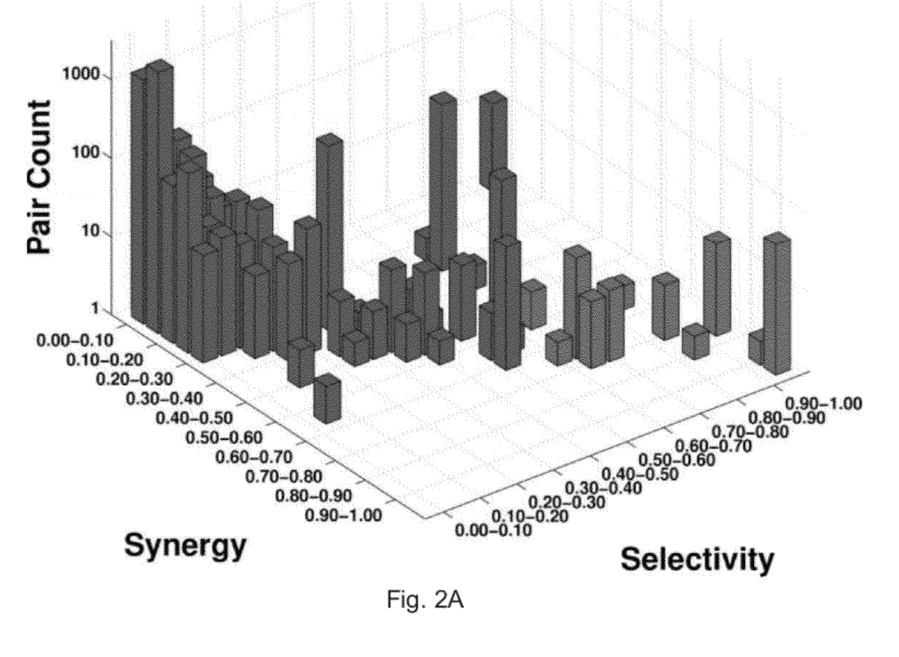

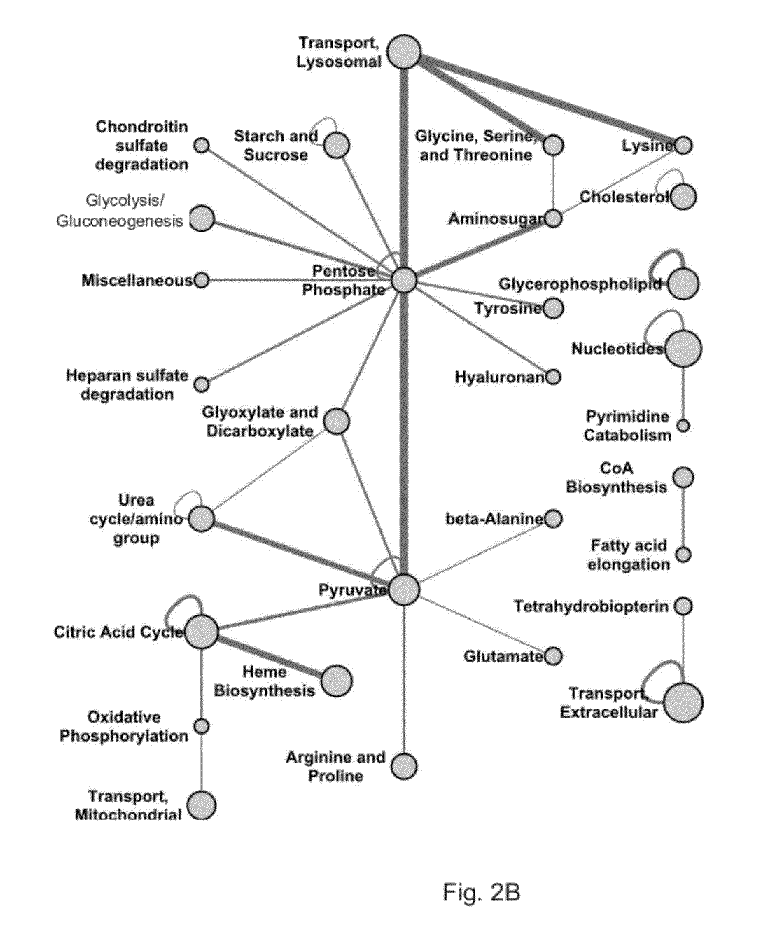

It has been suggested that the concept of synthetic lethality may be utilized in the selection of anticancer drug targets¹⁴. Synthetic lethal genes are common in metabolic networks due to their highly robust nature (resulting from backup mechanisms such as isozymes and alternative pathways¹⁵), and their identification via FBA was successfully demonstrated in microbial networks^{16,17}. To study synthetic lethal drug targets, all double gene knockdowns were systematically simulated in the cancer model. Each gene pair was assigned a synergy score, reflecting the additional drop in proliferation rate below the minimal rate achieved by its individual single knockdowns (in accordance with the commonly used “highest single agent” synergy model¹⁸). Filtering the identified synergistic drug targets (synergy score>0.5) based on their selectivity score (>0.6; computed when they are both knocked-down) resulted in a set of 133 synergistic and selective drug target pairs, involving 111 genes. The distribution of predicted drug target pairs across their synergy and selectivity scores is shown in FIG. 2a. The knockdown of 99 pairs (out of the identified 133 pairs) did not adversely affect growth in the generic model, suggesting that the targeting of these gene pairs may potentially involve less severe side-effects that are caused by the inhibition of proliferation of rapidly dividing somatic cells.

Synthetic lethal gene pairs, have been previously used to elucidate the modular structure of metabolic networks¹⁹. FIG. 2b shows a network of pathway associations of the predicted synergistic and highly selective drug target pairs. In FIG. 2b, node size represents the number of genes that participate in a pathway, while edge width represents the number of synergistic and selective pairs involving genes in the two connected pathways (its nodes). Exploration of the metabolic pathways in which the predicted synergistic and selective gene pairs participate (FIG. 2b) revealed that both the pentose phosphate pathway (PPP) and pyruvate metabolism play a central role, with 45% of the gene pairs having at least one target in these pathways. PPP is involved in the production of both NADPH (necessary for lipid and nucleotide biosynthesis as well as protection against oxidative stress) and ribose 5-phosphate (a nucleotide precursor), making it an attractive target for cancer therapy, though currently no inhibitors for this pathway are in clinical trials. In pyruvate metabolism, pyruvate carboxylase (PC; participating in 13 pairs) is notable; it is one of two major pathways that contribute to anaplerosis (i.e. the replenishment of TCA cycle intermediates), the other pathway being glutaminolysis.

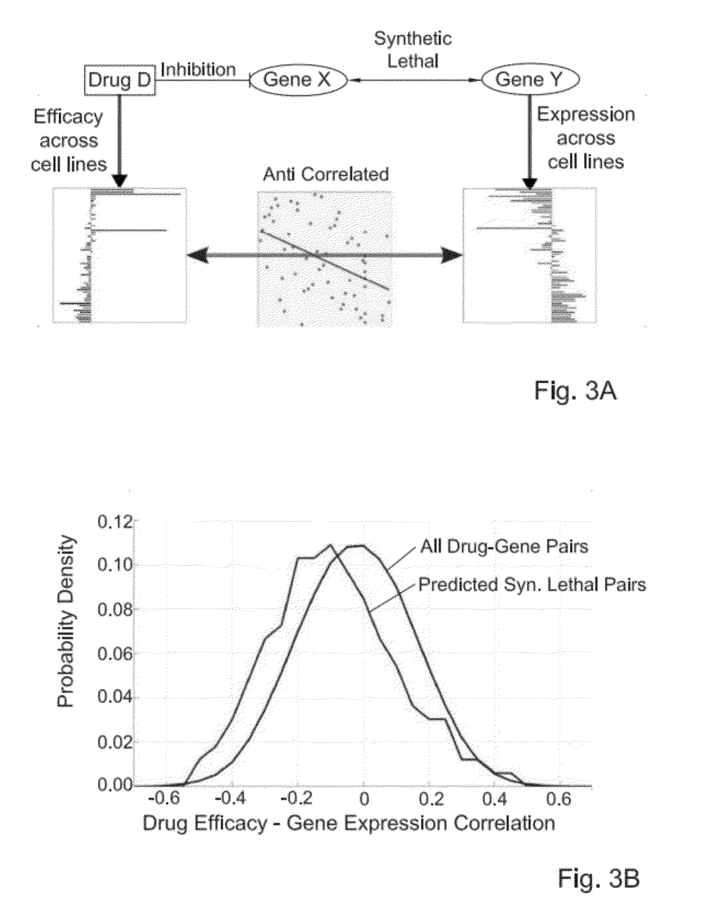

The specific targeting of a gene participating in a synergistic and selective pair whose interacting gene is inactivated causes the reduction in growth rate associated with the double knockdown. The inactivation of the inactive gene may result from cell-type and cancer-specific regulation of metabolic activity, or from the dysfunction of metabolic enzymes due to germline or cancer somatic mutations, both of which can decrease the buffering capacity of cancer cells. It was thus determined whether the targeting of a single gene participating in a predicted pair indeed has a known stronger experimental effect in specific cancer types in which its synergistic pair has a low metabolic activity. Growth inhibition measurements for 11 drugs¹⁰ and gene expression measurements over all NCI-60 cell-lines²⁰ were analyzed. FIG. 3 shows the relation between drug efficacy and the expression of paired target genes. FIG. 3a presents a schematic illustration of the expected relation between an efficacy of a drug and the expression of genes that have a synthetic lethal interaction with the drug's target. FIG. 3b presents a distribution of efficacy-expression correlation values for the set of predicted synthetic lethal drug-gene pairs, and for a background distribution of random pairs. It was found that drugs that target one of the genes in a predicted pair exert a significantly stronger inhibitory effect on proliferation in the cell-lines in which a paired target gene has a low expression level (p-value=0.02).

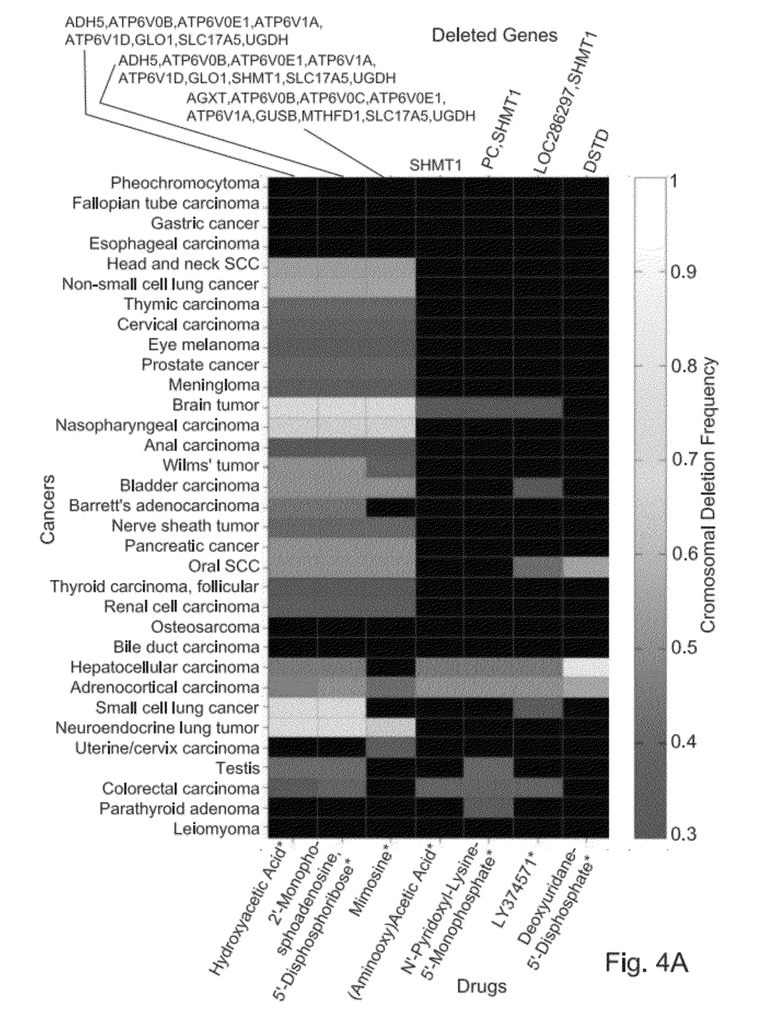

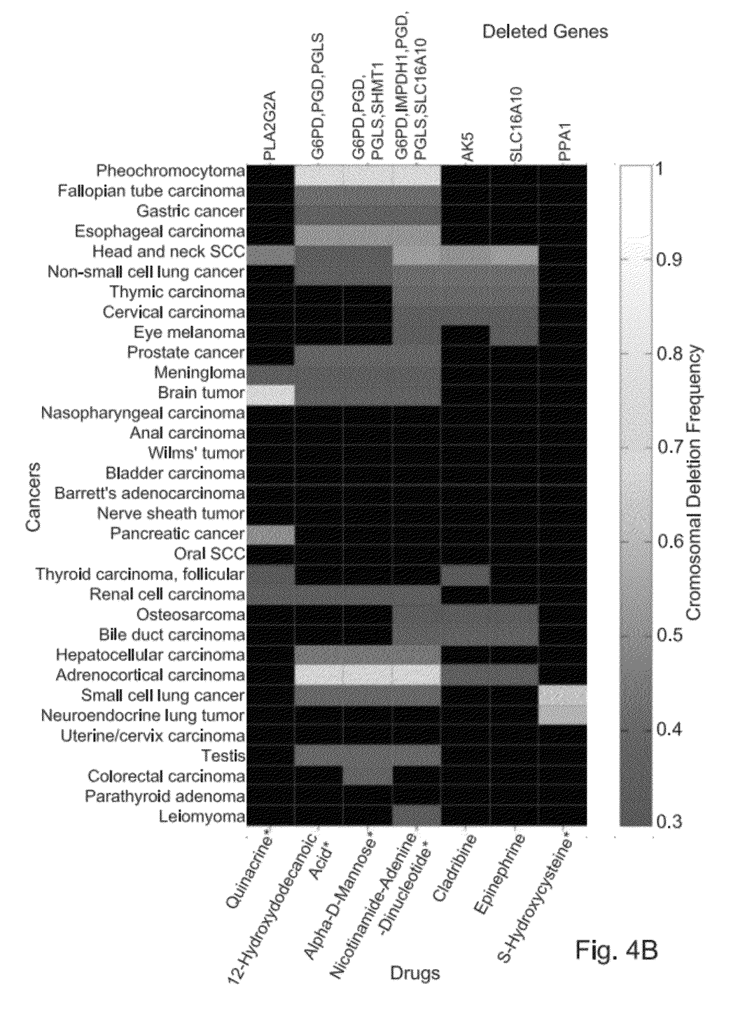

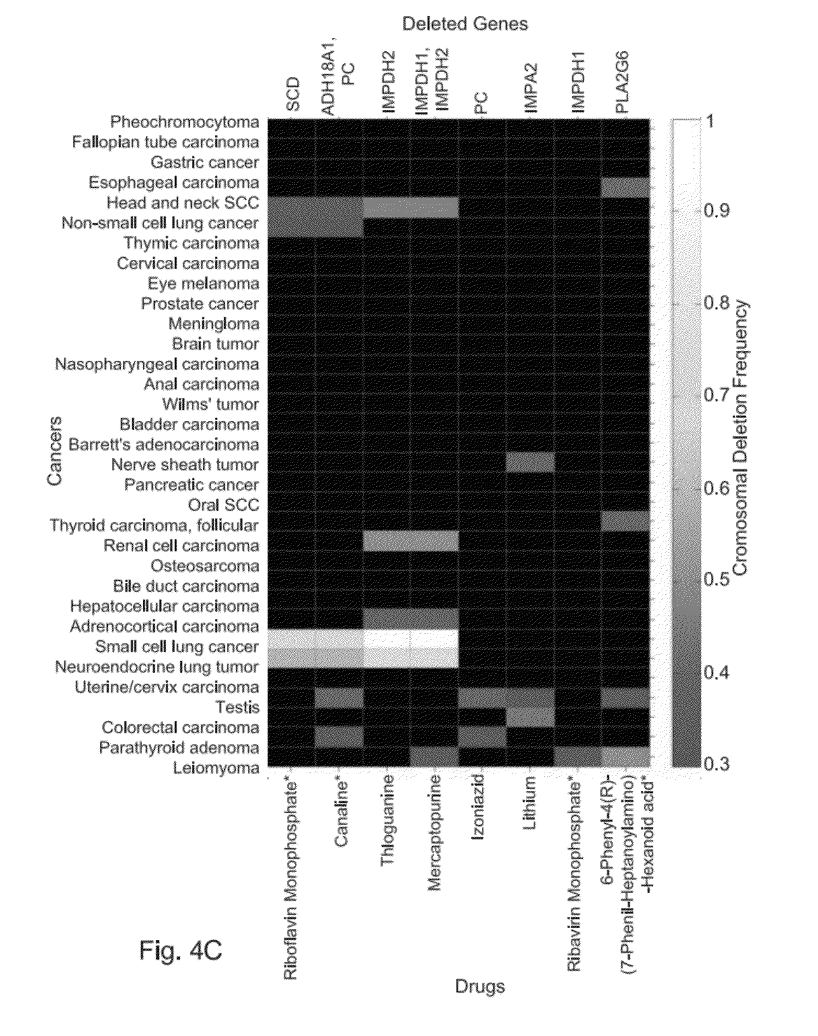

Germline mutations in four genes leading to dysfunctional enzymes, FH (fumarate hydratase) SDHB, SDHC, and SDHD (succinate dehydrogenase), have been found to be causally implicated in oncogenesis¹¹. FH forms predicted synergistic and selective pairs with 13 other genes (4 that already have drugs that target them), and these pairs can thus be used to target specific cancers associated with FH mutations such as leiomyoma, leiomyosarcoma or renal cell carcinoma¹¹ (notably, the tumor suppressor function of FH was recently shown to go beyond its TCA cycle activity, contributing to DNA damage response). Similarly, mutations in SDHB, SDHC and SDHD have been implicated in paraganglioma and pheochromocytoma, suggesting the specific usage of several existing drugs that target the two genes predicted to form synergistic and selective pairs with succinate dehydrogenase in these cancers. Additional somatic mutations in 13 genes that participate in 44 predicted synergistic and selective gene pairs were identified²¹. FIG. 5 shows the number of predicted synergistic and selective drug target pairs involving different genes with known somatic mutations in cancer²¹. For each gene in which cancer mutations were previously identified, the number of predicted synergistic and selective gene pairs in which it participates is shown. The number of paired genes targeted by existing drugs is shown in a red, while the number of paired genes which are not targeted by currently available drugs is shown in green. Chromosomal deletions of all genes that participate in the pairs have previously been identified in at least one out of 103 cancer types documented in the Atlas of Genetics and Cytogenetics in Oncology and Haematology²², further highlighting the clinical utility of targeting synthetic lethal genes in accordance with the specific cancers in which the pertaining chromosomal deletions occur. FIG. 4 shows the drugs predicted to target specific cancer types based on chromosomal loss of synthetic lethal participant genes. Specific drugs may be effective in treating specific types of cancer, based on the predictions of selective synthetic lethal gene pairs. Cancer types which show a high frequency (shown in yellow and white) of chromosomal deletions of specific genes are susceptible to drugs inhibiting the synthetic lethal complements of the genes. Experimental drugs are followed by an asterisk. In cases where multiple drugs target the same gene, only a single representative drug is shown.

For nine of the predicted synergistic selective gene pairs there are either approved or experimental drugs (not necessarily cancer related) that target both genes (this relative paucity is expected given the relative scarcity of treatments attacking multiple metabolic targets). In one such pair, both genes (IMPDH1 and IMPDH2 that code for isoenzymes of inosine monophosphate dehydrogenase) are targeted by the same approved anticancer drug (either by Mercaptopurine or Thioguanine). Another pair is FH (fumarate dehydrogenase) and ALAD (delta-aminolevulinic acid dehydratase), the latter targeted by aminolevulinic acid, an approved drug used for photodynamic therapy of cancer. The remaining seven pairs (with available drugs targeting both genes) are targeted either by approved non-anticancer drugs or experimental drugs. For example, one pair consists of two isoenzymes of inositol monophosphatase (IMPA1 and IMPA2), both targeted by lithium (clinically used for treating bipolar affective disorder), which was previously shown to reduce proliferation of esophageal cancer²³. Three additional gene pairs included the gene SHMT1 (serine hydroxymethyltransferase) targeted by the drug Mimosine, which was previously shown to inhibit proliferation of human cancer cells²⁴. For 60 out of the 133 predicted synergistic gene pairs there already exists a drug targeting one of the genes. Thus the additionally predicted gene forms an interesting candidate for potential drug targeting. The pair PNP (purine nucleoside phosphorylase) and AK5 (adenylate kinase), the former targeted by Cladribine, which is in use to treat hairy cell leukemia²⁵ constitutes such an example.

A systematic search for synergistic and selective combinations involving three target genes was also performed. This analysis identified 250 synergistic and selective gene triplets, five of them composed of genes that are all targeted by available drugs. Four of these gene triplets include G6PD (glucose-6-phosphate dehydrogenase), the first enzyme in the pentose phosphate pathway, and different genes in glycolysis or pyruvate metabolism pathways. An additional triplet consists of genes targeted by the following three drugs: Carmustine (a nonspecific alkylating antineoplastic agent), Cefdinir (a broad-spectrum antibiotic shown to target human Myeloperoxidase), and Fomepizole (antidote for ethylene glycol or methanol poisoning)¹³.

Methods

Gene expression data was collected from all cancer cell-lines in the NCI-60 collection and a core set of 197 cancer genes was assembled that are highly expressed (having a gene expression intensity above 200) in more than 90% of cell-line measurements. A set of metabolic reactions was sought consisting of reactions selected from the generic human model of Duarte et al⁴, containing the core reactions set that enables cellular proliferation. The metabolic network model was considered consistent if it enables the activation all of its reactions, i.e. for each reaction there exists a feasible flux distribution in the model (satisfying stoichiometric mass-balance and directionality constraints) in which this reaction carries a non-zero flux. A greedy search heuristic approach was employed that was based on iteratively pruning reactions from the generic human model in a random order, while maintaining the consistency of the pruned model with regard to its core reaction set (starting from a generic version of the human model that is consistent). In each pruning step, a reaction was removed from the cancer model being built only if its removal does not prevent the activation of the reactions in the core reaction set. Since the scanning order of the reactions may affect the resulting model, the algorithm was executed 1000 times, each time with a different, pruning order determined by a randomly selected permutation to construct multiple candidate models. The fraction of models that contain a certain reaction reflects the confidence score of the reaction, which indicates the extent to which it should be included in the final cancer model. Hence, to construct the final cancer model, the candidate models were aggregated, starting from the core reaction set and iteratively adding reactions ordered by their confidence scores, until a final model was obtained that was minimal and included all of the core reactions.

To predict gene contribution to biomass production, a growth reaction was added to the resulting model, representing the steady-state consumption of biomass compounds required for cellular proliferation. The stoichiometric coefficients of the growth reaction represented the relative molecular concentrations of 42 essential metabolites, including nucleotides, deoxynucleotides, amino-acids, lipids, etc. in human tissues. These relative concentrations were calculated based on data regarding mass composition of liver and muscle tissues [insert here references], as summarized in Table 1. A sensitivity analysis showed that the prediction performance of the cancer model was highly insensitive to the specific definition of biomass composition (see below). In all simulations, a standard RPMI-1640 medium was used, in accordance with the medium used in a reference shRNA experimental dataset²⁶.

Flux Balance Analysis (FBA) was used to simulate the effects of gene knockdowns on the biomass production rates of the proliferating cells²⁷. Genes whose knockdown reduces the maximal biomass production rate in more than 1% were considered to be growth-inducing.

The sensitivity of these results to uncertainty in biomass composition (and potential variation across cancer types) was estimated by adding random noise to the biomass coefficients and evaluating its effect on the predictive performance of growth-inducing genes. The random noise was drawn from a Gaussian distribution with a standard deviation of 50% of the original biomass coefficient values. For each choice of random biomass coefficients out of 1,000 runs, the prediction of growth-inducing genes via FBA was repeated and tested for enrichment of genes that contribute to growth based on the shRNA data from Luo et al.²⁶. The cancer model was found to be robust to different choices of biomass composition (in accordance with findings in microbial networks²⁸), with a mean p-value of 0.0505 and standard deviation of 0.0168.

The sensitivity of these results to the specific choice of threshold for predicting growth-inducing genes was evaluated by repeating the analysis for a wide range of thresholds in the range 0.001 to 0.2. It was found that the predictive performance is robust to the specific choice of threshold, with the corresponding p-values remaining significant in the range 0.0045 to 0.042.

As a further control, the predictive performance of the original generic human metabolic network itself was evaluated. It was found that the generic model predicts a smaller set of 92 growth-inducing genes that are also ranked as essential based on shRNA data, but with a p-value of 0.029, which is larger by an order of magnitude than that obtained by the cancer model (0.0045). The enrichment of these genes with known cancer mutation genes¹¹ is markedly lower than that obtained with the cancer model's predictions, with a p-value of 0.025 versus 0.0021 for the generic and cancer models, respectively. As another control, the predictive performance of the gene expression data alone (i.e. without utilizing a metabolic network model) was evaluated. It was found that the set of 197 highly expressed cancer genes (used as input in the cancer model) are not enriched with genes ranked as highly contributing to cancer growth based on the shRNA data (p-value 0.075), also providing a lower enrichment with known cancer mutation genes (p-value=0.0077).

Computing Selectivity Scores for Single and Double Drug Target Predictions

A selectivity score of a gene was used to represent the extent to which its knockdown obliterates cancer growth compared to its effect on ATP production in the normal, generic human model. The gene knockdown effect on growth rate was computed by applying FBA on the cancer model, denoting by WT_{growth} (cancer cell before knockout) and KO_{growth} (cancer cell after knockout) the growth rate before and after the knockdown, respectively. The gene knockdown effect on ATP production was computed by applying FBA on the generic human model, measuring the reduction in maximal achievable ATP production rate, and denoting by WTₐₜₚ and KOₐₜₚ the maximal ATP production rate before and after the knockdown, respectively. The selectivity score was defined as (KOₐₜₚ/WTₐₜₚ)*(1−KO_{growth}/WT_{growth}). A selectivity score of 1 denotes a highly selective knockdown that completely eliminates cancer growth without affecting ATP production of healthy cells, and a score of 0 denotes a highly nonselective knockdown. The selectivity for synergistic gene pairs was computed in an analogous manner, by simulating the effect of double knockdowns on growth and ATP production rates.

Predicting Synergistic Drug Targets

A synergy score for a gene pair was defined as the additional drop in growth rate below the minimal rate achieved by the single knockouts. Specifically, denoting by KO_{A}, KO_{B}, and KO_{AB}, the growth rates following the knockout of gene A, gene B, and the joint knockout of genes A and B, respectively, the synergy score used is defined as: KO_{AB}/min(KO_{A}, KO_{B}) (in accordance with the commonly used “highest single agent” synergy model¹⁸).

Calculation of the Statistical Significance of Drug Efficacy and Gene Expression Correlation

For each gene pair in which one gene is targeted by drug D and the other one is denoted G, we computed the Spearman correlation between the effective growth inhibition concentrations (GI-50) of D with the expression levels of G across the 60 cell-lines. The p-value was computed by a Wilcoxon test, comparing the distribution of Spearman correlation for all predicted synergetic drug-gene pairs with the distribution of Spearman correlation for a large random sample of drug-gene pairs.

Computer Implementation

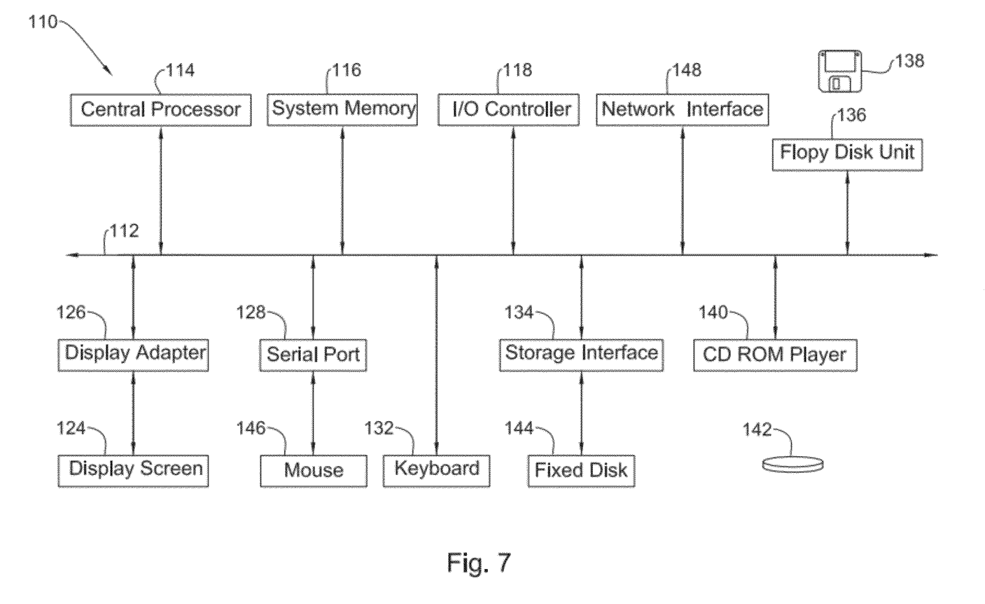

FIG. 7 depicts a block diagram of a host computer system 110 suitable for implementing the present invention. This diagram is merely an illustration and should not limit the scope of the claims herein. One of ordinary skill in the art would recognize other variations, modifications, and alternatives. Host computer system 110 includes a bus 112 which interconnects major subsystems such as a central processor 114, a system memory 116 (typically RAM), an input/output (I/O) controller 118, an external device such as a display screen 124 via a display adapter 126, a keyboard 132 and a mouse 146 via an I/O controller 118, a SCSI host adapter (not shown), and a floppy disk drive 136 operative to receive a floppy disk 138. Storage Interface 134 may act as a storage interface to a fixed disk drive 144 or a CD-ROM player 140 operative to receive a CD-ROM 142. Fixed disk 144 may be a part of host computer system 110 or may be separate and accessed through other interface systems.

The system has other features. A network interface 148 may provide a direct connection to a remote server via a telephone link or to the Internet. Network interface 148 may also connect to a local area network (LAN) or other network interconnecting many computer systems. Many other devices or subsystems (not shown) may be connected in a similar manner. Also, it is not necessary for all of the devices shown in FIG. 8 to be present to practice the present invention, as discussed below. The devices and subsystems may be interconnected in different ways from that shown in FIG. 8. The operation of a computer system such as that shown in FIG. 8 is readily known in the art and is not discussed in detail in this application. The databases and code to implement the present invention, may be operably disposed or stored in computer-readable storage media such as system memory 116, fixed disk 144, CD-ROM 140, or floppy disk 138.

Although the above has been described generally in terms of specific hardware, it would be readily apparent to one of ordinary skill in the art that many system types, configurations, and combinations of the above devices are suitable for use in light of the present disclosure. Of course, the types of system elements used depend highly upon the application.

1. A computer implemented method for creating a metabolic map of metabolic reactions by selecting metabolic reactions that are active in one or more cancer cells from a predetermined set of an integer N of metabolic reactions that can occur in a predetermined organism from which the one or more cells are derived, the method embodied in a set of instructions stored on a computer readable medium, the instructions capable of being executed by a computer processor, the method, comprising:
designating a core set of an integer M of metabolic reactions from the predetermined set of N metabolic reactions, the M core reactions occurring in the predetermined cell types of the organism or occurring under the predetermined conditions of the organism;
(a) for j=1 to an integer n of predetermined permutations of the metabolic reactions not in the core set of metabolic reactions:
1. for k=1 to N−M, determining whether inhibition of the k-th non-core reaction together with inhibition of all previously deleted non-core reactions results in inhibition of any one or more of the core reactions or results in inhibition of the flux of biomass metabolites to biomass;
2. if inhibition of the k-th non-core reaction together with inhibition of all previously deleted non-core reactions does not result in inhibition of any one or more of the core reactions and does not result in inhibition of the flux of biomass metabolites to biomass, deleting the k-th non-core reaction from the set of non-core reactions;
(b) calculating cₖ, cₖ being the number of permutations in the predetermined set of permutations for which the k-th non-core reaction is not deleted,
(c) determining a maximum value c of the cₖ for which inhibition of all non-core reactions having a cₖ less than or equal to c does not result in inhibition of any one or more of the core reactions or biomass production;
(d) determining a metabolic map to be the set of N metabolic reactions after deletion of the non-core reactions having a cₖ less than or equal to c.

2. The method according to claim 1 further comprising a step before step (c) of assigning a maximum flux to an uptake reaction of each of a plurality of metabolites, and step (d) further comprises a condition that the flux of the uptake reaction of each of the plurality of metabolites is less than the maximum uptake flux of the metabolite.

3. The method according to claim 1 wherein the step of determining whether inhibition of the k-th non-core reaction together with inhibition of all previously deleted non-core reactions results in inhibition of any one or more of the core reactions or biomass production comprises:
(e) for each core reaction,
determining whether a flux assignment to each reaction in the predetermined set of N reactions exists satisfying a first set of conditions comprising:
1. the flux of the k-th non-core reaction in the permutation is below a first predetermined threshold;
2. the flux of any previously deleted non-core reactions is below a second predetermined threshold;
3. the flux of the core reaction is above a predetermined third threshold;
4. the net flux of all metabolites is below a fourth predetermined threshold;
(f) determining whether a flux assignment to each reaction in the predetermined set of N reactions exists satisfying a second set of conditions comprising:
1. the flux of the k-th non-core reaction in the permutation is below a first predetermined threshold;
2. the flux of any previously deleted non-core reactions is below a second predetermined threshold;
3. the flux of the biomass production reaction is above a third predetermined threshold;
4. the net flux of all metabolites is below a fourth predetermined threshold; and
if a flux assignment does not exist, satisfying the first set of conditions for at least one core reaction or if a flux assignment does not exist satisfying the second set of conditions, determining that inhibition of the k-th non-core reaction together with inhibition of all previously deleted non-core reactions results in inhibition of any one or more of the core reactions or biomass production.

4. The method according to claim 2 wherein the step of determining whether inhibition of the k-th non-core reaction together with inhibition of all previously deleted non-core reactions results in inhibition of any one or more of the core reactions or biomass production comprises:
(e) for each core reaction,
determining whether a flux assignment to each reaction in the predetermined set of N reactions exists satisfying a first set of conditions comprising:
1. the flux of the k-th non-core reaction in the permutation is below a first predetermined threshold;
2. the flux of any previously deleted non-core reactions is below a second predetermined threshold;
3. the flux of the core reaction is above a predetermined third threshold;
4. the net flux of all metabolites is below a fourth predetermined threshold;
(f) determining whether a flux assignment to each reaction in the predetermined set of N reactions exists satisfying a second set of conditions comprising:
1. the flux of the k-th non-core reaction in the permutation is below a first predetermined threshold;
2. the flux of any previously deleted non-core reactions is below a second predetermined threshold;
3. the flux of the biomass production reaction is above a third predetermined threshold;
4. the net flux of all metabolites is below a fourth predetermined threshold; and
if a flux assignment does not exist, satisfying the first set of conditions for at least one core reaction or if a flux assignment does not exist satisfying the second set of conditions, determining that inhibition of the k-th non-core reaction together with inhibition of all previously deleted non-core reactions results in inhibition of any one or more of the core reactions or biomass production.

5. The method according to claim 1 wherein calculation of the flux of biomass metabolites to biomass comprises assigning a coefficient for each of a plurality of cellular metabolites, the coefficient being indicative of relative abundance of the cellular metabolite in a predetermined population of cells, and calculating the flux of biomass metabolites to biomass in a calculation involving the assigned coefficients.

6. A method for determining the relative significance of a set of one or more target metabolic reactions in cancer cells compared with normal, the method embodied in a set of instructions stored on a computer readable medium, the instructions capable of being executed by a computer processor, the method comprising:
(a) determining in the cancer cells a first rate of biomass production x₁ in the cancer cells when each of the one or more target metabolic reactions is not inhibited;
(b) determining in the cancer cells a second rate of biomass production x₂ in the cancer cells when all of the target metabolic reactions are inhibited;
(c) determining in the healthy cells a first rate of activity of an integer n of one or more predetermined test metabolic reactions y1 . . . yn in the healthy cells when each of the target metabolic reactions is not inhibited;
(d) determining in the cancer cells a second rate of activity of the n predetermined test metabolic reactions z₁ . . . zₙ in the healthy cells when all of the target metabolic reaction are inhibited; and
(e) calculating a selectivity score S of the set of target metabolic reactions using the algebraic expression S=(1−x2/x1)*min(zi/yi).

7. The method according to claim 6 wherein the step of determining a rate of biomass production in the cancer cells comprises:
designating a core set of an integer M of metabolic reactions from the predetermined set of N metabolic reactions, the M core reactions occurring in the predetermined cell types of the organism or occurring under the predetermined conditions of the organism;
(a) for j=1 to an integer n of predetermined permutations of the metabolic reactions not in the core set of metabolic reactions:
1. for k=1 to N−M, determining whether inhibition of the k-th non-core reaction together with inhibition of all previously deleted non-core reactions results in inhibition of any one or more of the core reactions or results in inhibition of the flux of biomass metabolites to biomass;
2. if inhibition of the k-th non-core reaction together with inhibition of all previously deleted non-core reactions does not result in inhibition of any one or more of the core reactions and does not result in inhibition of the flux of biomass metabolites to biomass, deleting the k-th non-core reaction from the set of non-core reactions;
(b) calculating cₖ, cₖ being the number of permutations in the predetermined set of permutations for which the k-th non-core reaction is not deleted,
(c) determining a maximum value c of the cₖ for which inhibition of all non-core reactions having a cₖ less than or equal to c does not result in inhibition of any one or more of the core reactions or biomass production;
(d) determining a metabolic map to be the set of N metabolic reactions after deletion of the non-core reactions having a cₖ less than or equal to c.

8. A method for determining a level of synergistic inhibition of biomass production of a set of K metabolic reactions R₁, R₂, . . . R_{K}, in cancer cells, the method embodied in a set of instructions stored on a computer readable medium, the instructions capable of being executed by a computer processor, the method comprising:
(a) for j from 1 to K, determining in the cancer cells a rate of biomass production yj when all of the reactions R₁ . . . Rⱼ₋₁, Rⱼ₊₁, . . . R_{K} are inhibited and the reaction Rⱼ is not inhibited;
(b) for j from 1 to K, determining in the cancer cells a rate of biomass production z when all of the reactions R₁ . . . R_{K} are inhibited;
(c) calculating a synergy score S′ of the K reactions R1, . . . RK using the algebraic expression S′=min(1−(z/yj)

9. The method according to claim 8 further comprising a step identifying sets of synthetically lethal reactions, a synthetically lethal set of reactions having a score S′ above a predetermined threshold.
